(19) United States
(12) Patent Application Publication
(10) Pub. No.: US 2018/0128245 A1
(43) Pub. Date: May 10, 2018

(54) Electrical Generation System

(71) Applicant: Derek Brown, Windsor (CA)

(72) Inventor: Derek Brown, Windsor (CA)

(21) Appl. No.: 15/343,262

(22) Filed: Nov. 4, 2016

(51) Int. Cl. F03D 9/00; F03D 9/25; F03B 13/12; H02K 7/18

(52) U.S. Cl. CPC F03D 9/003; F03D 9/25; F03D 9/007; F03D 9/008; F05B 2240/912; H02K 7/1838; H02K 7/1853; F05B 2220/706; F05B 2220/708; F03B 13/12

(57) ABSTRACT

An electrical generation system includes a plurality of wind generators. Each of the wind generators extends upwardly out of a body of water. Each of the wind generators is rotated by wind thereby facilitating each of the wind generators to generate electricity. A platform is slidably coupled to each of the wind generators. The platform travels upwardly and downwardly along the wind generator when the body of water raises and lowers. A plurality of motion units is operationally coupled between an associated one of the wind generator and the platform. Each of the motion units converts the upward and downward motion of the platform into electrical energy. A plurality of solar cells is coupled to the platform to convert sunlight into electricity.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to generation devices and more particularly pertains to a new generation device for converting wind, solar and tide motion into electrical energy.

### BRIEF SUMMARY OF THE INVENTION

An embodiment of the disclosure meets the needs presented above by generally comprising a plurality of wind generators. Each of the wind generators extends upwardly out of a body of water. Each of the wind generators is rotated by wind thereby facilitating each of the wind generators to generate electricity. A platform is slidably coupled to each of the wind generators. The platform travels upwardly and downwardly along the wind generator when the body of water raises and lowers. A plurality of motion units is operationally coupled between an associated one of the wind generator and the platform. Each of the motion units converts the upward and downward motion of the platform into electrical energy. A plurality of solar cells is coupled to the platform to convert sunlight into electricity.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an electrical generation system according to an embodiment of the disclosure.

FIG. 2 is a front view of an embodiment of the disclosure.

FIG. 3 is a bottom view of an embodiment of the disclosure.

FIG. 4 is a perspective in-use view of an embodiment of the disclosure.

FIG. 5 is a left side perspective in-use view of an embodiment of the disclosure.

FIG. 6 is a cross sectional view taken along line 6-6 of FIG. 2 of an embodiment of the disclosure.

### DETAILED DESCRIPTION OF THE INVENTION

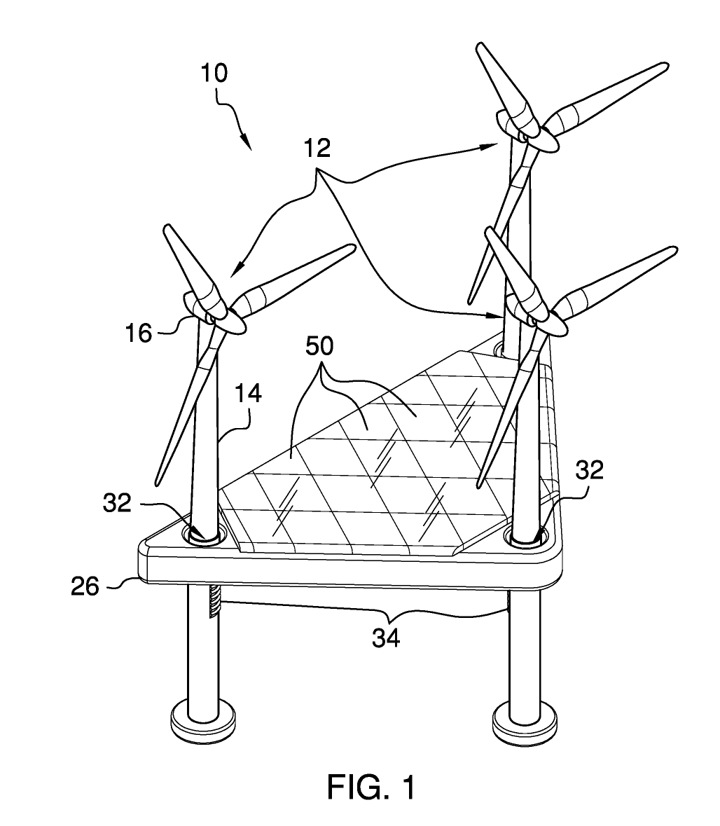

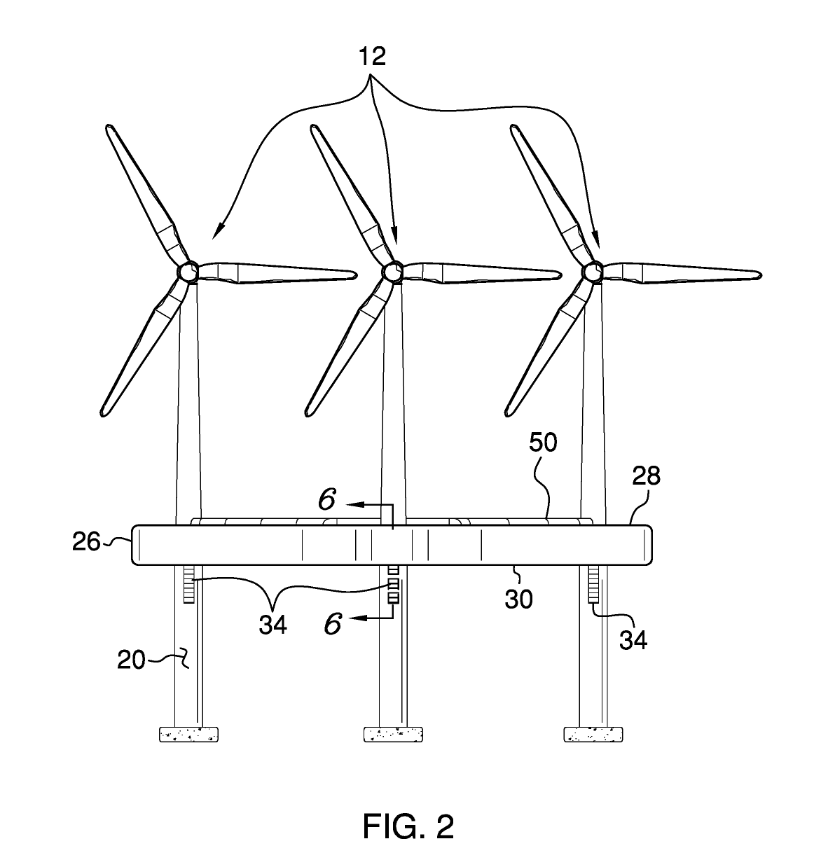

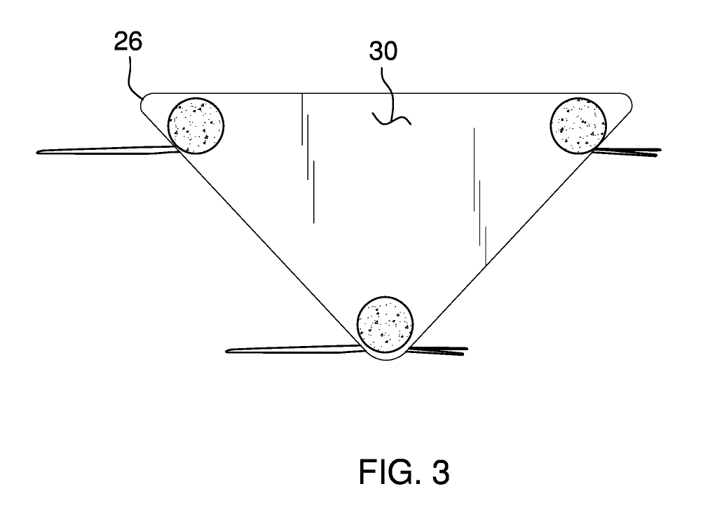

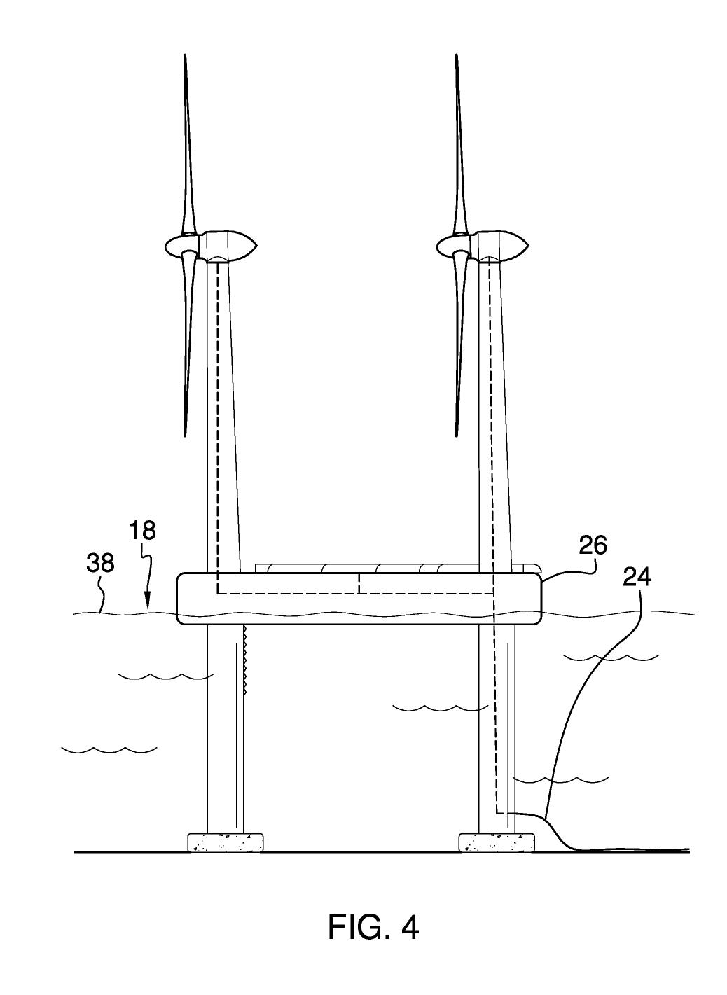

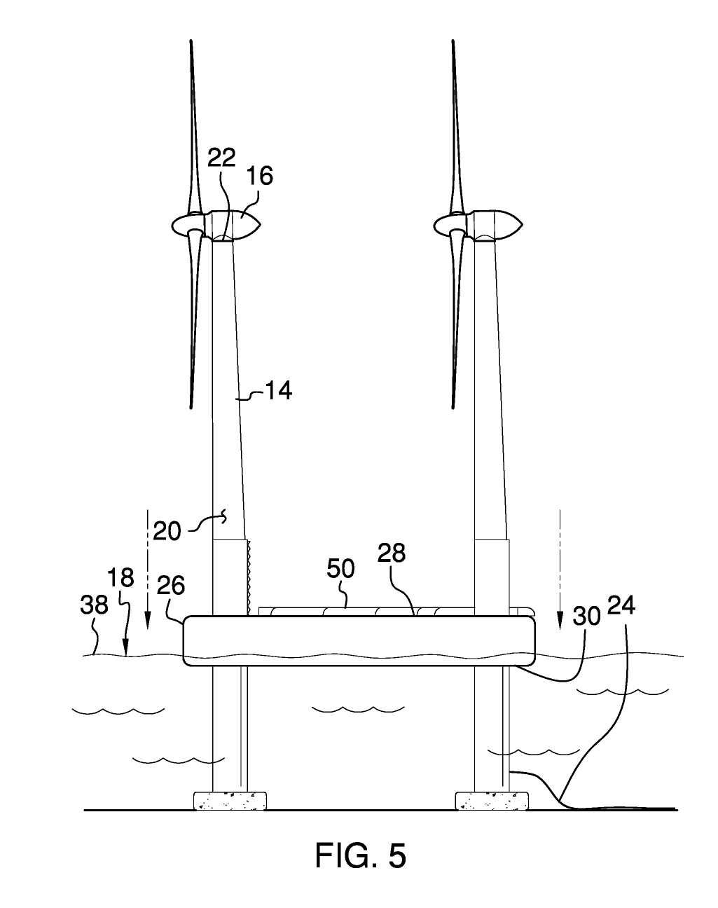

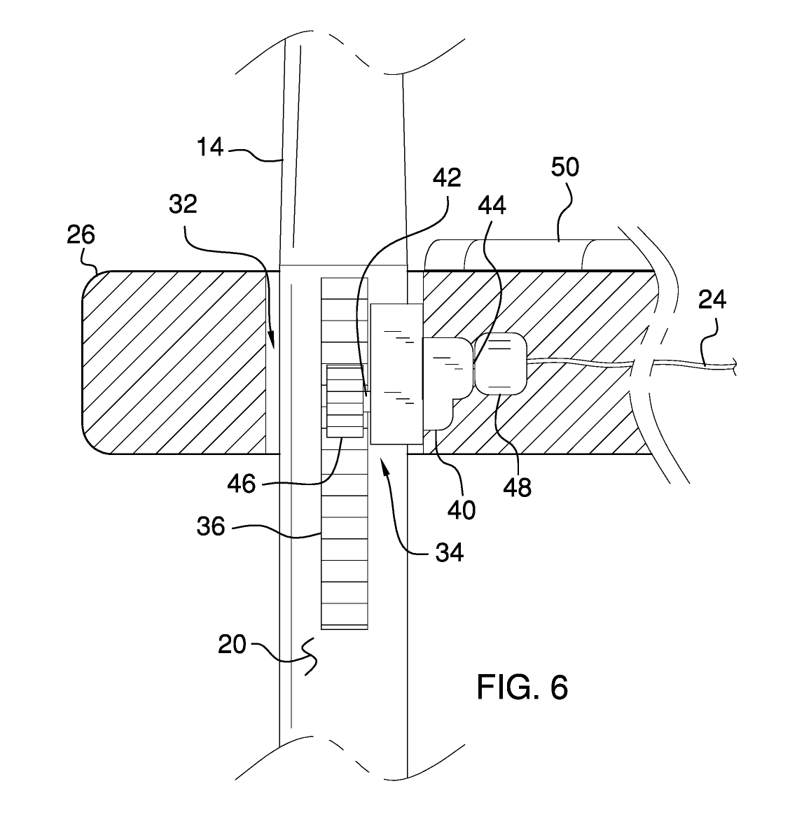

With reference now to the drawings, and in particular to FIGS. 1 through 6 thereof, a new generation device embodying the principles and concepts of an embodiment of the disclosure and generally designated by the reference numeral 10 will be described.

As best illustrated in FIGS. 1 through 6, the electrical generation system 10 generally comprises a plurality of wind generators 12. Each of the wind generators 12 includes a stanchion 14 and a turbine 16. The turbine 16 may include a plurality of fan blades and a generator. The stanchion 14 corresponding to each of the wind generators 12 extends upwardly out of a body of water 18. The body of water 18 may be an ocean or the like.

The stanchion 14 corresponding to each of the wind generators 12 has an outer surface 20 and a distal end 22 with respect to the body of water 18. The turbine 16 corresponding to each of the wind generators 12 is positioned on the corresponding distal end 22. The turbine 16 corresponding to each of the wind generators 12 is rotated by wind thereby. Thus, the turbine 16 corresponding to each of the wind generators 12 generates electricity. The turbine 16 corresponding to each of the wind generators 12 is electrically coupled to a power distribution system 24. The power distribution system 24 may be an electrical grid or the like.

A platform 26 is provided. The platform 26 is slidably coupled to the stanchion 14 corresponding to each of the wind generator. The platform 26 is comprised of a buoyant material. Thus, the platform 26 travels upwardly and downwardly along the corresponding stanchion 14 when the body of water 18 raises and lowers. The platform 26 moves according to tide level and wave action.

The platform 26 has a bottom surface 28 and a top surface 30. The platform 26 has a plurality of apertures 32. Each of the apertures 32 extends through the top surface 30 and the bottom surface 28. The apertures 32 are spaced apart from each other. The stanchion 14 corresponding to each of the wind generator extends through an associated one of the apertures 32.

A plurality of motion units 34 is provided. Each of the motion units 34 is operationally coupled between an associated one of the wind generators 12 and the platform 26. Each of the motion units 34 converts the upward and downward motion of the platform 26 into electrical energy. Each of the motion units 34 comprises a rack gear 36 coupled to the outer surface 20 of the stanchion 14 corresponding to the associated wind generator. The rack gear 36 is vertically oriented on the associated wind generator. Thus, the rack gear 36 extends above and below a surface 38 of the body of water 18.

A gear box 40 is provided. The gear box 40 is positioned within the platform 26. The gear box 40 has an input shaft 42 and an output shaft 44. The gear box 40 may be a speed increasing gear box or the like. Thus, the output shaft 44 rotates at a speed that is greater than a rotational speed of the input shaft 42.

A pinion gear 46 is provided. The pinion gear 46 is rotatably coupled to the input shaft 42. The pinion gear 46 engages the rack gear 36. Thus, the pinion gear 46 rotates when the platform 26 travels upwardly and downwardly.

A generator 48 is provided and the generator 48 is positioned within the platform 26. The generator 48 is coupled to the output shaft 44. The gear box 40 spins the generator 48 when the pinion gear 46 rotates. Thus, the generator 48 converts the motion of the platform 26 into electrical energy. The generator 48 is electrically coupled to the power distribution system 24. Moreover, the generator 48 may be an electrical generator or the like.

A plurality of solar cells 50 is provided. Each of the solar cells 50 is coupled to the platform 26. Thus, each of the solar cells 50 is exposed to sunlight thereby facilitating each of the solar cells 50 to convert sunlight into electricity. Each of the solar cells 50 is positioned on the top surface 30 of the platform 26. Each of the solar cells 50 is electrically coupled to the power distribution system 24.

In use, the stanchion 14 corresponding to each wind generator is anchored to the bottom of the body of water 18. The corresponding stanchion 14 is vertically oriented to extend upwardly from the body of water 18. The platform 26 floats on the surface 38 of the body of water 18. The generator 48 corresponding to each motion unit is rotated when the platform 26 moves upwardly and downwardly. Each of the wind generator and the solar cells 50 produce electrical energy. Each of the wind generators 12 and the platform 26 are position off shore in an ocean or the like.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An electrical generation system comprising:
a plurality of wind generators, each of said wind generators being configured to engage a bottom of a body of water and extend upwardly out of the body of water such that each said wind generator remains in a static position relative to movement of the body of water, each of said wind generators being configured to be rotated by wind thereby facilitating each of said wind generators to generate electricity, each of said wind generators being configured to be electrically coupled to a power distribution system;
a platform being slidably coupled to each of said wind generators, said platform being comprised of a buoyant material wherein said platform is configured to travel upwardly and downwardly along said wind generator when the body of water raises and lowers;
a plurality of motion units, each of said motion units being operationally coupled between an associated one of said wind generators and said platform wherein each of said motion units is configured to convert the upward and downward motion of said platform into electrical energy; and
a plurality of solar cells, each of said solar cells being coupled to said platform wherein each of said solar cells is configured to be exposed to sunlight thereby facilitating each of said solar cells to convert sunlight into electricity.

2. The system according to claim 1, wherein each of said wind generators includes a stanchion and a turbine, said stanchion corresponding to each of said wind generators having an outer surface and a distal end with respect to the body of water, said turbine corresponding to each of said wind generators being positioned on said corresponding distal end.

3. The system according to claim 1, wherein:
each of said wind generators includes a stanchion; and
said platform has a bottom surface and a top surface, said platform having a plurality of apertures, each of said apertures extending through said top surface and said bottom surface, said apertures being spaced apart from each other, said stanchion corresponding to each of said wind generator extending through an associated one of said apertures.

4. The system according to claim 2, wherein each of said motion units comprises a rack gear being coupled to said outer surface of said stanchion corresponding said associated wind generator, said rack gear being vertically oriented on said associated wind generator wherein said rack gear is configured to extend above and below a surface of the body of water.

5. The system according to claim 1, further comprising a gear box being positioned within said platform, said gear box having an input shaft and an output shaft.

6. The system according to claim 5, further comprising:
a rack gear; and
a pinion gear being rotatably coupled to said input shaft, said pinion gear engaging said rack gear such that said pinion gear rotates when said platform travels upwardly and downwardly.

7. The system according to claim 6, further comprising a generator being positioned within said platform, said generator being coupled to said output shaft such that said gear box spins said generator when said pinion gear rotates wherein said generator is configured to convert the motion of said platform into electrical energy, said generator being configured to be electrically coupled to the power distribution system.

8. The system according to claim 1, wherein:
said platform has a top surface; and
each of said solar cells being positioned on said top surface of said platform, each of said solar cells being configured to be electrically coupled to the power distribution system.

9. An electrical generation system comprising:
a plurality of wind generators, each of said wind generators including a stanchion and a turbine, said stanchion corresponding to each of said wind generators being configured to engage a bottom of a body of water and extend upwardly out of the body of water such that each said wind generator remains in a static position relative to movement of the body of water, said stanchion corresponding to each of said wind generators having an outer surface and a distal end with respect to the body of water, said turbine corresponding to each of said wind generators being positioned on said corresponding distal end wherein said turbine corresponding to each of said wind generators is configured to be rotated by wind thereby facilitating said turbine corresponding to each of said wind generators to generate electricity, said turbine corresponding to each of said wind generators being configured to be electrically coupled to a power distribution system;
a platform being slidably coupled to said stanchion corresponding to each of said wind generators, said platform being comprised of a buoyant material wherein said platform is configured to travel upwardly and downwardly along said corresponding stanchion when the body of water raises and lowers, said platform having a bottom surface and a top surface, said platform having a plurality of apertures, each of said apertures extending through said top surface and said bottom surface, said apertures being spaced apart from each other, said stanchion corresponding to each of said wind generators extending through an associated one of said apertures;
a plurality of motion units, each of said motion units being operationally coupled between an associated one of said wind generators and said platform wherein each of said motion units is configured to convert the upward and downward motion of said platform into electrical energy, each of said motion units comprising:
a rack gear being coupled to said outer surface of said stanchion corresponding said associated wind generator, said rack gear being vertically oriented on said associated wind generator wherein said rack gear is configured to extend above and below a surface of the body of water,
a gear box being positioned within said platform, said gear box having an input shaft and an output shaft,
a pinion gear being rotatably coupled to said input shaft, said pinion gear engaging said rack gear such that said pinion gear rotates when said platform travels upwardly and downwardly, and
a generator being positioned within said platform, said generator being coupled to said output shaft such that said gear box spins said generator when said pinion gear rotates wherein said generator is configured to convert the motion of said platform into electrical energy, said generator being configured to be electrically coupled to the power distribution system; and
a plurality of solar cells, each of said solar cells being coupled to said platform wherein each of said solar cells is configured to be exposed to sunlight thereby facilitating each of said solar cells to convert sunlight into electricity, each of said solar cells being positioned on said top surface of said platform, each of said solar cells being configured to be electrically coupled to the power distribution system.
